(19) United States
(12) Patent Application Publication
(10) Pub. No.: US 2010/0096414 A1
(43) Pub. Date: Apr. 22, 2010

(54) Refillable Bottle Having Pour-Through Dispenser

(76) Inventor: Stephen R. Dennis, Danville, CA (US)

Correspondence Address: THE CLOROX COMPANY, P.O. BOX 24305, OAKLAND, CA, 94623-1305, US

(21) Appl. No.: 12/254,144

(22) Filed: Oct. 20, 2008

(51) Int. Cl. B67D 5/40; B67D 5/06; B05B 9/01

(52) U.S. Cl. 222/383.1; 239/526; 222/331

(57) ABSTRACT

Described is a bottle for fluids, such as liquid cleaners and the like. The bottle includes a dispenser for delivering the fluid from the bottle. The dispenser may include a refill channel formed therethrough, thereby permitting a user to refill the bottle without the need to remove the dispenser from the bottle. The dispenser may be attached to the bottle with any conventional means, such as a snap-fit connection, a screw-fit connection, a bayonet connector or the like.

### BACKGROUND OF THE INVENTION

1. Field of the Invention

This invention relates generally to containers and pump assemblies for liquids, such as liquid cleaners and the like. More particularly, the present invention relates generally to bottles having a dispenser through which the bottle may be refilled of its contents.

2. Description of the Related Art

Trigger sprayers are those types of sprayers that can be held in a single hand of the user and operated by the fingers of the user's hand to dispense fluid from a container connected to the trigger sprayer. A prior art trigger sprayer typically includes a sprayer housing that contains a pump chamber and piston, a sprayer fluid supply passageway that fluidly communicates a fluid inlet opening, sometimes also referred to as a connector aperture, with the pump chamber. The trigger sprayer further includes a finger operated trigger that actuates the pump piston. The manually manipulated trigger is mounted on the sprayer housing for pivoting movement by the fingers of the user's hand, the trigger being operatively connected to the pump piston of the trigger sprayer. Manual manipulation of the trigger operates the pump, which draws fluid from the container connected to the trigger sprayer and dispenses the fluid from the sprayer housing. A fluid discharge passageway fluidly communicates the pump chamber with a sprayer fluid outlet that discharges fluid from the sprayer housing upon actuation of the pump piston. Finally, a nozzle assembly is often connected to the sprayer housing at the sprayer fluid outlet opening. Various types of nozzle assemblies are known. A typical nozzle assembly is adjustable to provide different discharge patterns of the fluid dispensed from the sprayer housing. For example, the fluid can be dispensed in a stream or spray pattern, or as a foam.

A sprayer connector, adapted to secure the sprayer housing to the fluid container is typically integrally formed with or otherwise coupled to the sprayer housing. As noted above the sprayer connector includes a connector aperture therethrough that forms the inlet opening of the fluid supply passageway to the pump chamber of the sprayer housing. A dip tube is often sealingly coupled to the connector aperture. The dip tube extends through a neck of the container and into fluid contents of the container. The dip tube fluidly communicates the container with the fluid supply passageway of the sprayer housing. The dip tube may be a separate straw-like element that attaches to the sprayer connector. Alternatively, the dip tube may be an integral dip tube, formed as part of the bottle itself, as disclosed in U.S. Pat. No. 4,863,071.

The bottles and many, if not all, of the components of the trigger sprayers are typically made of plastic. Therefore, the bottles are usually sold as disposable units, wherein the user simply discards or recycles the entire bottle and trigger sprayer once the contents of the bottle are depleted.

Sometimes, a user may be provided with a refill for the container, thereby allowing re-use of the bottle and trigger sprayer. Refillable containers, however, have several disadvantages which has limited their popularity. For example, when the trigger sprayer is to be removed from the container, there is often a column of fluid remaining with the pump or dip tube that can dribble during refill as may occur in containers with dip tubes.

Fill-through conduits formed in a pump dispenser have been disclosed in the art. U.S. Pat. No. 6,345,738 describes a fill-through pump body with a closure. The fill conduit may be used for the initial filling of the bottle during manufacture. Once the bottle is filled, the fill conduit may be non-removably closed. In the dispenser of the '738 patent, the consumer would not detect any difference between the bottled filled during manufacture with the fill conduit disclosed therein and a conventional bottle.

Furthermore, many prior art trigger sprayers, including those useful with bottles having integral or conventional dip tubes, are connected to their containers by an internally threaded sprayer connector. To firmly secure the trigger sprayer on the container neck, the sprayer connector is positioned on the container neck and rotated. Complementary screw threading provided on the inner surface of the cap and the outer surface of the container neck securely attaches the trigger sprayer to the container. The need to unthread and rethread the sprayer connector for each refill may cause wear and failure of the threads or may compromise the seal between the trigger sprayer and the bottle.

Accordingly, what is needed is a bottle and dispenser that may allow refilling the contents thereof without requiring the user to remove the trigger sprayer from the bottle.

### SUMMARY OF THE INVENTION

In accordance with the principles of the present invention, in one embodiment, a dispenser comprises a bottle; a fluid dispensing mechanism attached to the bottle; and a refill channel through the fluid dispensing mechanism, the refill channel enabling refill of the bottle without removal of the fluid dispensing mechanism from the bottle.

According to a further embodiment of the present invention, a fluid dispensing mechanism for attachment to a bottle comprises a spray engine; and a refill channel formed through the fluid dispensing mechanism, the refill channel permitting fluid to be poured into the bottle through an opening in the fluid dispensing mechanism.

According to a another embodiment of the present invention, a cleaning kit comprises a bottle fitted with a fluid dispensing mechanism; a refill channel extending through the fluid dispensing mechanism, the refill channel enabling refill of the bottle without removal of the fluid dispensing mechanism from the bottle; and a cleaning fluid.

In one embodiment, the dispenser of the present invention further includes a cover fluidly sealing the refill channel.

In yet another embodiment, the dispenser of the present invention includes a depending end portion extending a length into a bottle when the fluid dispensing mechanism is attached to the bottle.

In still a further embodiment, the dispenser of the present invention includes a breather channel, the breather channel permitting the escape of air in the bottle displaced by fluid poured into the bottle via the refill channel.

In yet a further embodiment, the dispenser of the present invention has a spray engine of a fluid dispensing mechanism located forward of a dispensing mechanism supply tube. The refill channel is located rearward of the trigger supply tube.

Further features and advantages of the present invention will become apparent to those of ordinary skill in the art in view of the detailed description of embodiments below, when considered together with the attached drawings and claims.

### BRIEF DESCRIPTION OF THE DRAWINGS

The foregoing aspects and others will be readily appreciated by the skilled artisan from the following description of illustrative embodiments when read in conjunction with the accompanying drawings, in which:

FIG. 1 shows a perspective view of a trigger sprayer having a refill channel formed therethrough according to the present invention;

FIG. 2 shows a bottom perspective view of a bayonet-fit trigger sprayer having a refill channel formed therethrough according to the present invention;

FIG. 3 shows a cross-sectional view of a snap-fit trigger sprayer, with a forward spray engine for connection to a bottle with an integral dip tube, having a refill channel formed therethrough according to the present invention.

### DETAILED DESCRIPTION

Reference will now be made to the drawings wherein like numerals refer to like parts throughout. For ease of description, the components of this invention are described in the normal (upright) operating position, and terms such as upper, lower, horizontal, etc., are used with reference to this position. It will be understood, however, that the components embodying this invention may be manufactured, stored, transported, used, and sold in an orientation other than the position described.

Figures illustrating the components of this invention show some conventional mechanical elements that are known and that will be recognized by one skilled in the art. The detailed descriptions of such elements are not necessary to an understanding of the invention, and accordingly, are herein presented only to the degree necessary to facilitate an understanding of the novel features of the present invention.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

Broadly, the present invention provides a bottle for fluids, such as liquid cleaners and the like. The bottle may include a dispenser for delivering the fluid from the bottle. The dispenser may include a refill channel formed therethrough, thereby permitting a user to refill the bottle without the need to remove the dispenser from the bottle. The dispenser may be attached to the bottle with a snap-fit connection, a screw-fit connection, a bayonet connector or the like.

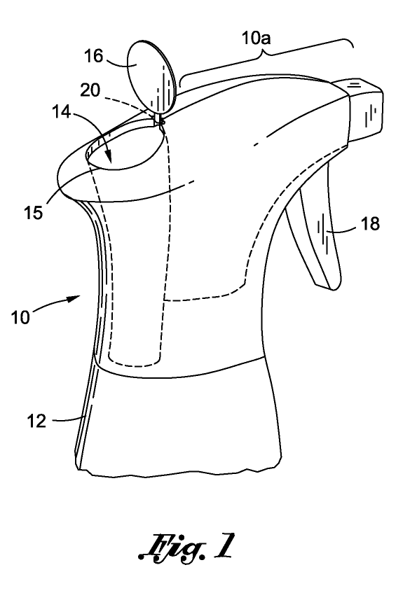

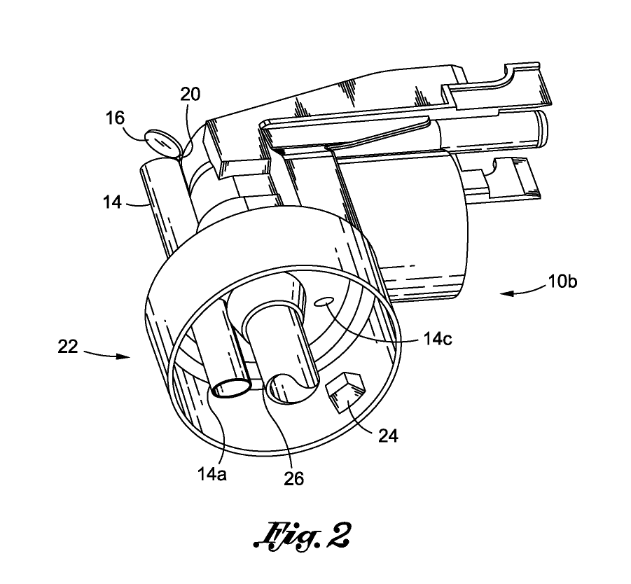

More particularly, FIG. 1 shows a perspective view of an exemplary trigger sprayer 10 having a refill channel 14 formed therethrough according to the present invention. The trigger sprayer 10 may have any conventional trigger engine 10a for delivering fluid from a bottle 12. For example, the trigger sprayer 10 may have a trigger 18 that a user may pull to dispense fluid from the bottle 12.

The refill channel 14 may allow a user to add fluid, such as a cleaning liquid, to the bottle 12. The refill channel 14 may have a cover 16 attached via a hinge 20 to the trigger sprayer 10. The cover 16 may fluidly seal the fluid within the bottle 12, thereby preventing spillage if the bottle 12 is tipped over while containing fluid. The refill channel 14 may be located to the rear (relative to the direction of fluid expulsion from the trigger sprayer 10, as indicated by the arrow in FIG. 1) of the trigger engine 10a of the trigger sprayer 10. While not shown in FIG. 1, alternatively, the refill channel 14 may be located to the side of the trigger engine 10a, or centrally located to provide a refill channel through the trigger engine 10a. Typically, the refill channel 14 may be formed in the trigger sprayer 10 to provide an ergonomic trigger sprayer 10 that may fit into a user's hand comfortably during use.

The refill channel 14 may have a constant cross-sectional area along the length thereof. Alternatively, as shown in FIG. 1, the refill channel 14 may have a larger cross-sectional area at an open end 15 thereof. This design may provide a larger opening where the user can easily pour contents therein with less spillage as may occur with a smaller opening.

The trigger sprayer 10 with refill channel 14 may allow a user to purchase a single bottle 12 and trigger sprayer 10 and refill the bottle 12 when it becomes empty. This may save the consumer money with each refill and may also reduce solid wastes, providing consumers with a “green” alternative to buying a new bottle and trigger sprayer each time it becomes empty.

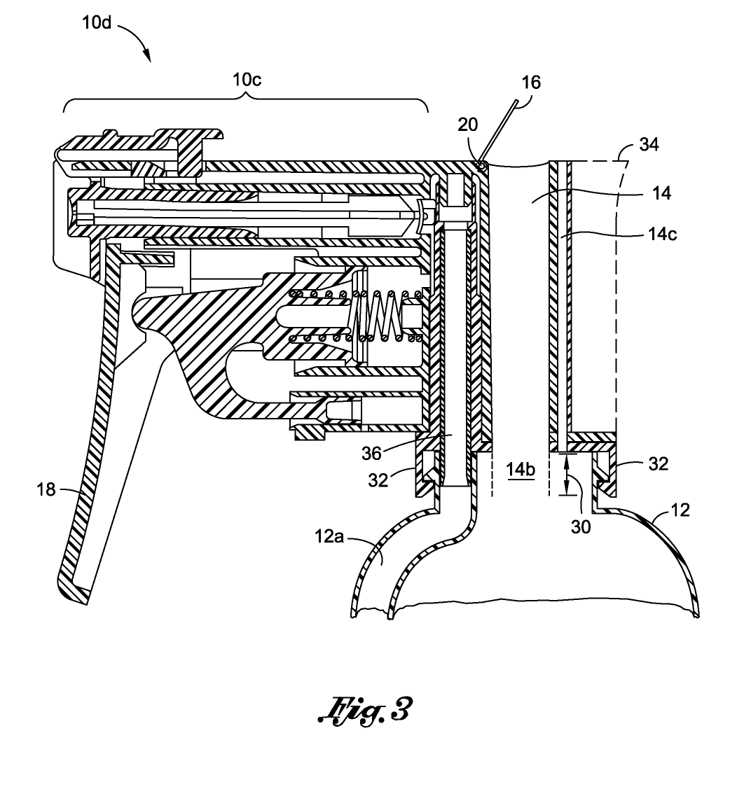

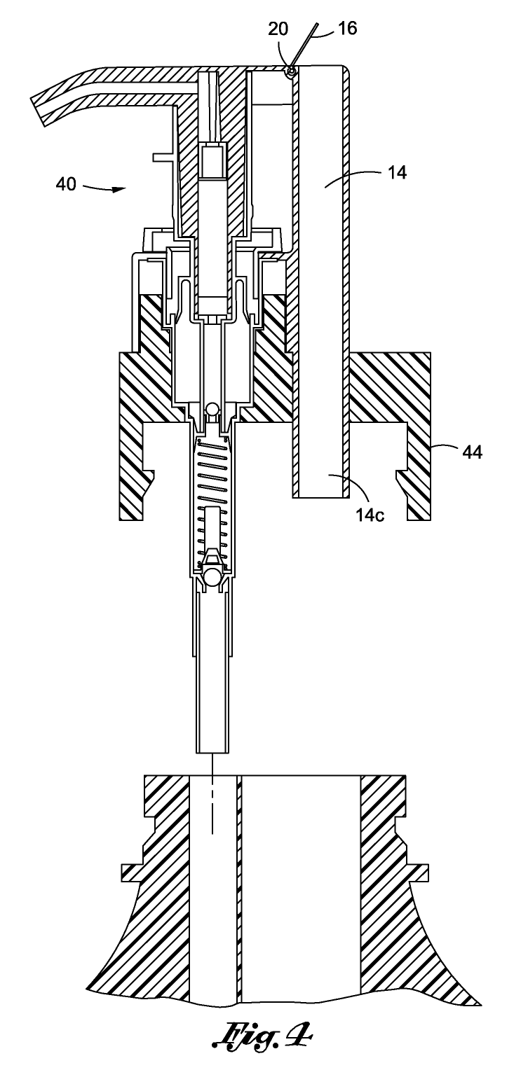

The trigger sprayer 10 may be attached to the bottle by any conventional means, such as a screw-cap (not shown), a bayonet-fit (see FIG. 2) or a snap-fit (see FIG. 3). Referring to FIG. 2, there is shown a bottom perspective view of a bayonet-fit trigger sprayer 10b having a refill channel 14 formed therethrough according to the present invention. The bayonet-fit trigger sprayer 10b may include a centrally located dip tube 26 for drawing fluid from the bottle (not shown). The bayonet-fit trigger sprayer 10b may further include an attachment lug 24 for connecting the bayonet-fit connector 22 to the bottle.

The bayonet-fit connector 22 may be any conventional connector for attaching the bayonet-fit trigger sprayer 10b to the bottle. For example, one bayonet-fit connector 22 that may be useful in the present invention is described in commonly owned U.S. patent application Ser. No. 12/142,090, herein incorporated by reference.

Similar to that described above with reference to FIG. 2, the refill channel 14 may be located at any location in the trigger sprayer 10b. The refill channel 14 may optionally include a depending end portion 14a which may extend into the bottle when the trigger sprayer 10b is attached thereto. Without depending end portion 14a, the adhesive tension of the fluid poured into the refill channel 14 may cause the fluid to flow down the side of the bottle. However, with the depending end portion 14a, the fluid may be poured directly into the bottle. When the fluid added to the bottle is a concentrate, the depending end portion 14a may ease mixing of the concentrate with a diluent (such as water) already present in the bottle.

Referring now to FIG. 3, there is shown a cross-sectional view of a snap-fit trigger sprayer 10c, with a forward spray engine 10d for connection to a bottle 12 with an integral dip tube 12a, and having a refill channel 14 formed therethrough according to the present invention. The trigger sprayer 10c may be attached to the bottle 12 with a snap-fit connector 32.

Similar to FIG. 2, the embodiment of FIG. 3 has refill channel 14 with a depending end portion 14b. The depending end portion 14b may extend a distance 30 into the bottle 12.

The refill channel 14 may include a breather channel 14c formed in a portion thereof. The breather channel 14c may prevent splattering of fluid added through the refill channel 14. Without the breather channel 14c, as air is displaced from the bottle 12 when fluid is added through the refill channel 14, the air passes back up through the fluid in the refill channel 14, causing the fluid to splatter. With the breather channel 14c, the displaced air may pass out of the bottle 12 through the breather channel without causing the fluid in the refill channel 14 to splatter. The cover 16 may cover both the refill channel 14 and the breather channel 14c when the breather channel 14c is adjacent to the refill channel 14, as in FIG. 3. In FIG. 2, the breather channel 14c is separated from the refill channel 14 and not under the cover 16.

The forward spray engine 10c may be located on one side of a trigger supply tube 36. The trigger supply tube 36 may fluidly connect with the integral dip tube 12a of the bottle 12. The refill channel 14 may be located adjacent to the trigger supply tube 36, as shown in FIG. 3. The trigger sprayer 10c may have an ergonomic design configured to fit into a user's hand. The ergonomic design may have a configuration, for example, as shown by a dotted line 34 in FIG. 3.

The present invention further includes a cleaning kit that may include, in a consumer package, a bottle having a fluid dispensing mechanism, as described above, with a refill channel formed therethrough. The cleaning kit may include a cleaning fluid. The cleaning fluid may be pre-packaged and included in the bottle, or the cleaning fluid may be included separate from the bottle, or both. The cleaning kit may include a refill bottle having a cleaning fluid therein. This cleaning fluid may be in the form of a concentrated solution of the cleaning fluid, wherein the concentrated cleaning fluid may be mixed with a diluent, such as water.

While the present invention has been described with reference to trigger sprayers, any fluid dispensing mechanism may be used in the present invention. For example, the trigger sprayer of FIG. 3 may be replaced with a conventional pump mechanism as shown in FIG. 4, where the pump mechanism 40 includes a refill channel 14 and depending end portion 14c according the present invention to permit refill thereof.

This invention has been described herein in detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A dispenser comprising:
a bottle;
a fluid dispensing mechanism attached to the bottle; and
a refill channel extending through the fluid dispensing mechanism, the refill channel enabling refill of the bottle without removal of the fluid dispensing mechanism from the bottle.

2. The dispenser of claim 1, wherein the fluid dispensing mechanism is a pump.

3. The dispenser of claim 1, wherein the fluid dispensing mechanism is a trigger sprayer.

4. The dispenser of claim 1, further comprising a cover fluidly sealing the refill channel.

5. The dispenser of claim 1, wherein the cover is hingedly attached to the fluid dispensing mechanism.

6. The dispenser of claim 1, wherein the refill channel includes a depending end portion extending a length into the bottle when the fluid dispensing mechanism is attached to the bottle.

7. The dispenser of claim 1, further comprising a breather channel, the breather channel permitting the escape of air in the bottle displaced by fluid poured into the bottle via the refill channel.

8. The dispenser of claim 1, wherein the bottle has an integral dip tube.

9. The dispenser of claim 8, wherein a spray engine of the fluid dispensing mechanism is located forward of a dispensing mechanism supply tube.

10. The dispenser of claim 9, wherein the refill channel is located rearward of the dispensing mechanism supply tube.

11. The dispenser of claim 1, wherein the fluid dispensing mechanism is attached to the bottle by one of a screw-cap, a bayonet-fit and a snap-fit.

12. A fluid dispensing mechanism for attachment to a bottle, the fluid dispensing mechanism comprising:
a spray engine; and
a refill channel formed through the fluid dispensing mechanism, the refill channel permitting fluid to be poured into the bottle through an opening in the fluid dispensing mechanism.

13. The fluid dispensing mechanism of claim 12, further comprising a cover fluidly sealing the refill channel, the cover being hingedly attached to the fluid dispensing mechanism.

14. The fluid dispensing mechanism of claim 12, wherein:
a spray engine of the fluid dispensing mechanism is located forward of a dispensing mechanism supply tube; and
the refill channel is located rearward of the dispensing mechanism supply tube.

15. The fluid dispensing mechanism of claim 12, wherein the fluid dispensing mechanism is a trigger sprayer attached to the bottle by one of a screw-cap, a bayonet-fit and a snap-fit.

16. 1. A dispenser comprising:
a bottle with an integral dip tube;
a fluid dispensing mechanism with a dispensing mechanism supply tube and attached to the bottle; and
a refill channel having a cover fluidly sealing the refill channel and the refill channel extending through the fluid dispensing mechanism, the refill channel enabling refill of the bottle without removal of the fluid dispensing mechanism from the bottle and the dispensing mechanism located forward of the dispensing mechanism supply tube and the refill channel located rearward of the dispensing mechanism supply tube;
wherein the refill channel includes a depending end portion extending a length into the bottle when the fluid dispensing mechanism is attached to the bottle.

17. The dispenser of claim 16, wherein the fluid dispensing mechanism is a trigger sprayer.

18. The dispenser of claim 17, further comprising a breather channel, the breather channel permitting the escape of air in the bottle displaced by fluid poured into the bottle via the refill channel.

19. The dispenser of claim 18, wherein the breather channel is adjacent to the refill channel and under the refill channel cover.

20. The dispenser of claim 18, wherein the breather channel is separated from the refill channel and not under the refill channel cover.
